(19) United States
(12) Patent Application Publication
(10) Pub. No.: US 2009/0307593 A1
(43) Pub. Date: Dec. 10, 2009

(54) SYSTEM AND METHOD FOR MANAGING MEDIA PLAY TASKS AND STORAGE MEDIUM CONTAINING INSTRUCTIONS THEREOF

(75) Inventor: CHIEN-HSUN CHU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/417,653

(22) Filed: Apr. 3, 2009

(30) Foreign Application Priority Data
Jun. 6, 2008 (CN) 200810302053.3

(51) Int. Cl. G06F 3/00

(52) U.S. Cl. 715/716

(57) ABSTRACT

A method for managing media play tasks includes generating a media stack, storing current media play tasks into the media stack, and setting a play priority for each of the media play tasks, and selecting a media play task from the media stack, and playing the selected media play task. The method further includes storing a new media play task into the media stack if the new media play task is generated, and setting a play priority for the new media play task, suspending the media play task being played if the play priority of the new media play task is not lower than the play priority of the media play task being played, and playing the new media play task. A system performing the method and storage medium supporting instructions for executing the method are also provided.

### BACKGROUND

1. Technical Field

Embodiments of the present disclosure relate to media management, and particularly to a system and method for managing media play tasks, and a storage medium containing instructions thereof.

2. Description of Related Art

Currently, compact handheld devices such as mobile phones are broadly utilized by people in daily life for multiple functions, including playing audio files.

However, current handheld devices can often not manage multiple media play tasks at the same time. For example, if a new media play task is generated, a current media play task will be interrupted and cannot resume automatically when the new media play task is complete, presenting considerable user inconvenience.

### BRIEF DESCRIPTION OF THE DRAWINGS

FIG. 1 is a schematic diagram of one embodiment of a system for managing media play tasks; and

FIG. 2 is a flowchart of one embodiment of a method for managing media play tasks.

### DETAILED DESCRIPTION

All of the processes described below may be embodied in, and fully automated via, functional code modules executed by one or more general purpose mobile devices or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

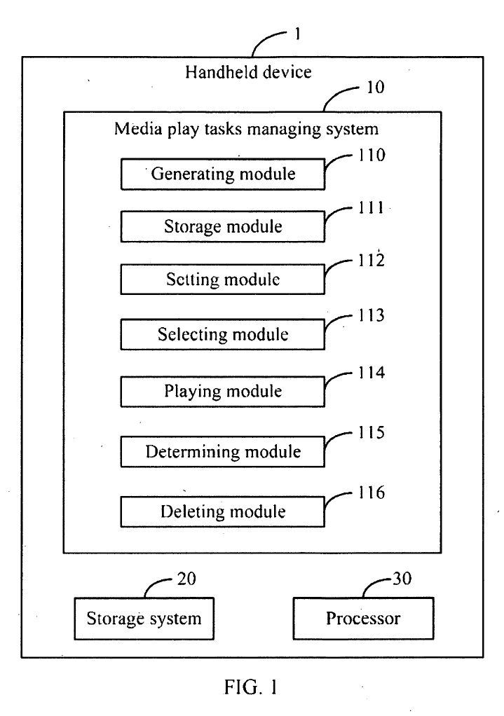

FIG. 1 is a schematic diagram of one embodiment of a system 10 for managing media play tasks. In one embodiment, the system 10 is shown here executed in a handheld device 1, which can be a cell phone, digital camera, personal digital assistant (PDA), or other device, al whilst remaining well within the scope of the disclosure. Furthermore, the handheld device 1 includes at least a storage system 20 and a processor 30.

In one embodiment, the system 10 includes a generating module 110, a storing module 111, a setting module 112, a selecting module 113, a playing module 114, a determining module 115, and a deleting module 116. In one exemplary embodiment, the modules 110-116 may comprise computerized instructions and be stored in the storage system 20. The processor 30 may execute the computerized instructions to implement one or more methods for the handheld device 1.

The generating module 110 is configured for generating a media stack in an operating system of the handheld device 1. In this embodiment, the media stack is a data structure compliant with a first in first out (FIFO) protocol. Further details of the media stack will be explained below.

The storing module 111 is configured for storing current media play tasks in the media stack. For example, if an enter sequence of the one or more MP3 files is a.mp3→b.mp3→c.mp3, the MP3 file of a.mp3 is selected for playing firstly according to the FIFO protocol.

The setting module 112 is configured for setting a play priority for each of the media play tasks.

The selecting module 113 is configured for reading all media play tasks having a top play priority, and further selecting the first media play task entering the media stack from the read media play tasks having the top play priority.

The playing module 114 is configured for playing a first media file corresponding to the selected media play task.

The determining module 115 is configured for determining if a new media play task is generated during execution of the first media file.

The storing module 111 is further configured for storing the new media play task if generated.

The setting module 112 is further configured for setting a play priority for the new media play task according to a type of the new media play task. In one embodiment, the types of the media play task include a MP3 type, a MP4 type, and an AVI type, etc.

The determining module 115 is further configured for determining if the play priority of the new media play task is lower than the play priority of the selected media play task being played.

The playing module 114 is further configured for suspending execution of the first media file if the play priority of the new media play task is not lower than the play priority of the selected media task, and playing a second media file corresponding to the new media play task.

The determining module 115 is further configured for determining if execution of a current media file, such as the first media file or the second media file is complete.

The deleting module 116 is configured for deleting the media play task corresponding to the current media file from the media stack if execution of the current media file is complete.

The determining module 115 is further configured for determining if there are any media play tasks in the media stack.

The selecting module 113 is further configured for selecting a next media play task from the media stack if there is a media play task in the media stack.

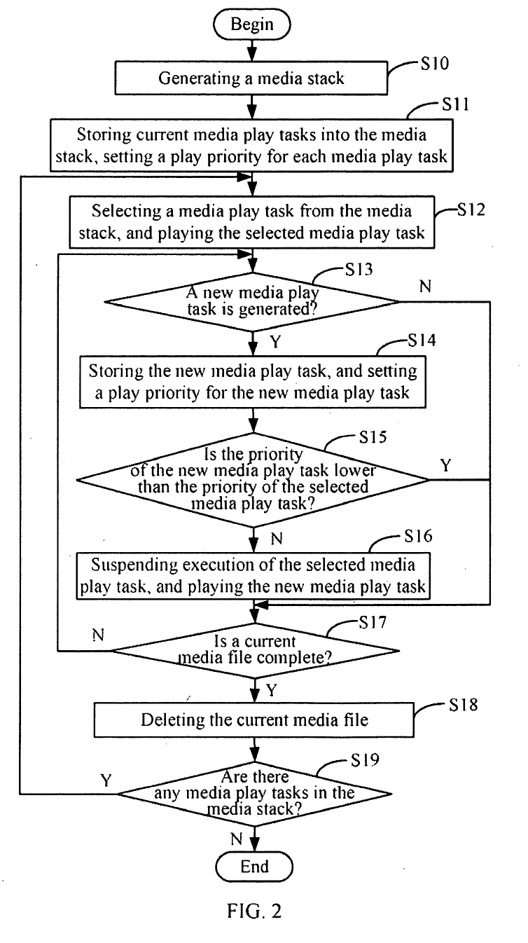

FIG. 2 is a flowchart of one embodiment of a method for managing media play tasks. Depending on the embodiment, additional blocks may be added, others removed, and the ordering of the blocks may be changed.

In block S10, the generating module 110 generates a media stack in an operating system of the handheld device 1.

In block S11, the storing module 111 stores current media play tasks into the media stack. For example, the storing module 111 can store one or more MP3 files, an alarm clock tone, a short message tone, and a keystroke tone into the media stack. Then, the setting module 112 sets a play priority for each of the media play tasks. For example, the setting module 112 can set a top play priority for the one or more MP3 files, a second play priority for the alarm clock tone and the short message tone, and a third play priority for the keystroke tone.

In block S12, the selecting module 113 reads all media play tasks having a top play priority, and further selects the media play task first entering the media stack from the read media play tasks having the top play priority. For example, if an enter sequence of the one or more MP3 files, such as, for example, first play task, second play task, and third play task having play priority of second play task, first play task, and third play task, an MP3 file of the second play task is selected for playing. Then, the playing module 114 plays a media file corresponding to the selected media play task.

In block S13, the determining module 115 determines if a new media play task is generated during execution of the first media file. If a new task is generated, block S14 is executed. Otherwise, if no new task is generated, then block S17 is executed.

In block S14, the storing module 111 stores the new media play task into the media stack and setting module 112 sets a play priority for the new media play task according to the type of the new media play task.

In block S15, the determining module 115 determines if the play priority of the new media play task is lower than the play priority of the selected media play task. If the play priority of the new media play task is lower than the play priority of the selected media play task, block S17 is executed. Otherwise, if the play priority of the new media play task is not lower than the play priority of the selected media play task, then block S16 is executed.

In block S16, the playing module 114 suspends execution of the first media file corresponding to the selected media play task, and plays a second media file corresponding to the new media play task.

In block S17, the determining module 115 determines if execution of a current media file, such as the second media file, is complete. If execution of a current media file is complete, block S18 is executed. Otherwise, if execution of a current media file is not complete, then block S13 is executed.

In block S18, the deleting module 116 deletes the media play task corresponding to the current media file from the media stack.

In block S19, the determining module 115 determines if there are any media play tasks in the media stack. If there is a media play task in the media stack, block S12 is executed. Otherwise, if there is no media play task in the media stack, then the process terminates.

The present embodiment provides a media stack to store current media play tasks. If a current media play task is suspended by a new media play task, the current media task can be saved in the media stack so as to resume playing when the new media play task is complete.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for managing media play tasks in a handheld electronic device, the method comprising:
(a) generating a media stack in an operating system of the handheld device;
(b) storing current media play tasks into the media stack, and setting a play priority for each of the media play tasks;
(c) reading all media play tasks having a top play priority, and further selecting a media play task having first entered the media stack from the read media play tasks having the top play priority;
(d) playing a first media file corresponding to the selected media play task;
(e) determining if a new media play task is generated during execution of the first media file;
(f) storing the new media play task into the media stack if the new media play task is generated, and setting a play priority for the new media play task according to a type of the new media play task;
(g) determining if the play priority of the new media play task is lower than the play priority of the selected media play task; and
(h) suspending execution of the first media file if the play priority of the new media play task is not lower than the play priority of the selected media play task, and playing a second media file corresponding to the new media play task.

2. The method according to claim 1, after step (h) further comprising:
(i) determining if execution of a current media file is complete;
(g) deleting the media play task corresponding to the current media file from the media stack if the execution of the current media file is complete;
(k) determining if there are any media play tasks in the media stack; and
(l) returning to step (c) if there is a media play task in the media stack.

3. The method according to claim 2, wherein step (i) is executed if no new media play task is generated in step (e) or the play priority of the new media play task is lower than the play priority of the selected media play task in step (g).

4. The method according to claim 2, wherein step (e) is executed upon determination that the execution of the current media file is not complete in step (i).

5. A storage medium having stored thereon instructions that, when executed by a processor of a handheld device, causes the processor to perform a method for managing media play tasks in the handheld device, the method comprising:
(a) generating a media stack in an operating system of the handheld device;
(b) storing current media play tasks into the media stack, and setting a play priority for each of the media play tasks;
(c) reading all media play tasks having a top play priority, and further selecting a media play task having first entered the media stack from the read media play tasks having top play priority;
(d) playing a first media file corresponding to the selected media play task;
(e) determining if a new media play task is generated during execution of the first media file;
(f) storing the new media play task into the media stack if the new media play task is generated, and setting a play priority for the new media play task according to a type of the new media play task;
(g) determining if the play priority of the new media play task is lower than the play priority of the selected media play task; and
(h) suspending execution of the first media file if the play priority of the new media play task is not lower than the play priority of the selected media play task, and playing a second media file corresponding to the new media play task.

6. The storage medium according to claim 5, wherein the medium is selected from the group consisting of a hard disk drive, a compact disc, a digital video disc, and a tape drive.

7. A system for managing media play tasks, comprising:
a generating module configured for generating a media stack in an operating system of a handheld device;
a storing module configured for storing current media play tasks into the media stack;
a setting module configured for setting a play priority for each of the media play tasks;
a selecting module configured for reading all media play tasks having a top play priority, and further selecting a media play task first enters the media stack from the read media play tasks having the top play priority;
a playing module configured for playing a first media file corresponding to the selected media play task;
a determining module configured for determining if a new media play task is generated during execution of the first media file;
the storing module further configured for storing the new media play task into the media stack if the new media play task is generated;
the setting module further configured for setting a play priority for the new media play task according to a type of the new media play task;
the determining module further configured for determining if the play priority of the new media play task is lower than the play priority of the selected media play task; and
the playing module further configured for suspending execution of the first media file if the play priority of the new media play task is not lower than the play priority of the selected media play task, and playing a second media file corresponding to the new media play task.

8. The system according to claim 7, further comprising a deleting module, wherein:
the determining module is further configured for determining if execution of a current media file is complete; and
the deleting module is configured for deleting the media play task corresponding to the current media file from the media stack if execution of the current media file is complete.

9. The system according to claim 8, wherein:
the determining module is further configured for determining if any media play tasks are present in the media stack; and
the selecting module further configured for selecting a subsequent media play task from the media stack if a media play task is present in the media stack.

10. The system according to claim 7, wherein the handheld device is selected from the group consisting of a cell phone, a digital camera, and a personal digital assistant (PDA).
